(19) United States
(12) Patent Application Publication
(10) Pub. No.: US 2017/0067548 A1
(43) Pub. Date: Mar. 9, 2017

(54) Linkage Actuator

(71) Applicant: Peter Neuhaus, Pensacola, FL (US)

(72) Inventor: Peter Neuhaus, Pensacola, FL (US)

(21) Appl. No.: 15/237,793

(22) Filed: Aug. 16, 2016

Related U.S. Application Data
(60) Provisional application No. 62/205,992, filed on Aug. 17, 2015.

(51) Int. Cl. F16H 25/20; G01L 5/00; F16H 25/22

(52) U.S. Cl. CPC F16H 25/2015; F16H 25/2204; G01L 5/0061; F16H 2025/2043; F16H 2025/204; F16H 2025/2075

(57) ABSTRACT

A novel linkage actuator. A frame mounts a screw and a motor driving the screw in a controlled fashion. Rotating the screw moves a ball nut engaged to the screw in a linear fashion, along with a carrier connected to the ball nut. An output link is pivotally connected to another part of the same frame. A transfer link is pivotally connected to the carrier on its first end and pivotally connected to the output link on its second end. In this arrangement, turning the screw causes the output link to pivot.

### CROSS-REFERENCES TO RELATED APPLICATIONS

This non-provisional application claims the benefit of an earlier-filed provisional application under 37 C.F.R. section 1.53(c). The earlier application was assigned Ser. No. 62/205,992. It was filed on Aug. 17, 2015 and listed the same inventor.

### STATEMENT REGARDING FEDERALLY SPONSORED RESEARCH OR DEVELOPMENT

Not applicable

### MICROFICHE APPENDIX

Not Applicable

### BACKGROUND OF THE INVENTION

1. Field of the Invention

The present invention pertains to the field of mechanical actuators.

2. Description of the Related Art

It is often a goal in the field of mechanical design to carefully control the rotational motion, velocity, and acceleration of one linkage with respect to another. The present invention provides a novel actuator that allows such control.

### BRIEF SUMMARY OF THE PRESENT INVENTION

The present invention comprises a novel linkage actuator. A frame mounts a screw and a motor driving the screw in a controlled fashion. Rotating the screw moves a ball nut engaged to the screw in a linear fashion, along with a carrier connected to the ball nut. An output link is pivotally connected to another part of the same frame. A transfer link is pivotally connected to the carrier on its first end and pivotally connected to the output link on its second end. In this arrangement, turning the screw causes the output link to pivot.

### BRIEF DESCRIPTION OF THE SEVERAL VIEWS OF THE DRAWINGS

FIG. 1 is a side elevation view, showing the novel linkage actuator in a first position.

FIG. 2 is a side elevation view, showing the novel linkage actuator in a second position.

FIG. 3 is a block diagram depicting an exemplary control system used to control the angular position of the output link.

FIG. 4 is a block diagram, depicting an exemplary control system used to control the torque applied to the output link.

### REFERENCE NUMERALS IN THE DRAWINGS

2 actuator

10 frame

12 output link

14 screw

16 motor

18 transfer link

20 trunnion

22 pivot pin

24 pivot pin

26 load cell

28 encoder

30 linear bearing

32 bearing way

34 ballnut

36 carrier

38 controller

40 encoder/torque sensor

41 input block

42 summation block

44 summation block

46 control function

48 conversion function

50 numerical differentiator

52 low pass filter

54 input block

56 summation block

58 summation block

60 control function

62 control function

64 numerical differentiator

66 low pass filter

68 numerical differentiator

70 low pass filter

72 control function

74 hardware-based low pass filter

76 moving averager

78 low pass filter

80 numerical differentiator

82 low pass filter

### DETAILED DESCRIPTION OF THE INVENTION

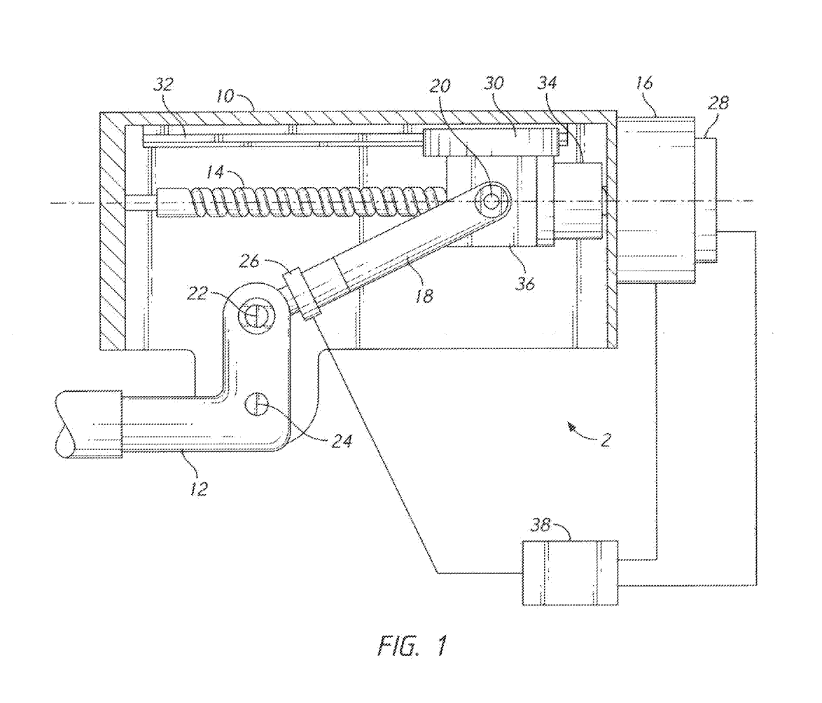

FIG. 1 depicts actuator 2 in a first position. Frame 10 mounts the other components. It will typically be anchored to something—such as one link of a multi-link moving system. Output link 12 moves under the control of the actuator. Screw 14 is rotationally mounted in frame 10. It is free to rotate but otherwise constrained. Ballnut 34 is driven to the left and right in the view as screw 14 turns. The ballnut and screw are preferably a close-tolerance assembly so that precisely controlled rotation of screw 14 produces precisely controlled linear motion of ballnut 34. This type of assembly is familiar to those skilled in the field of linear motion control.

Carrier 36 is connected to ballnut 34 and moves therewith. Linear bearing 30 is attached to carrier 36 and slides along bearing way 32. Motor 16 is attached to frame 10. It drives screw 14. Transfer link 18 divides into a fork proximate carrier 36 and pivotally attaches to carrier 36 via two trunnions 20 (one on either side of the carrier). The opposite end of transfer link 18 pivotally connects to output link 12 at pivot pin 22. Load cell 26 is also included in the transfer link. Load cell 26 is configured to accurately measure the linear load (tension or compression) in transfer link 18.

Output link 12 pivots about pivot pin 24, which is secured to frame 10. The output link may assume any desired shape. Only a portion of this link is shown but it may be quite long.

Encoder 28 provides information regarding the relative and absolute rotational position of screw 14. A linear encoder may be included for the position of carrier 36. This information, along with the information from load cell 26, is preferably sent to controller 38. Controller 38, which may include a processor running software, uses this information to control the motion of the actuator.

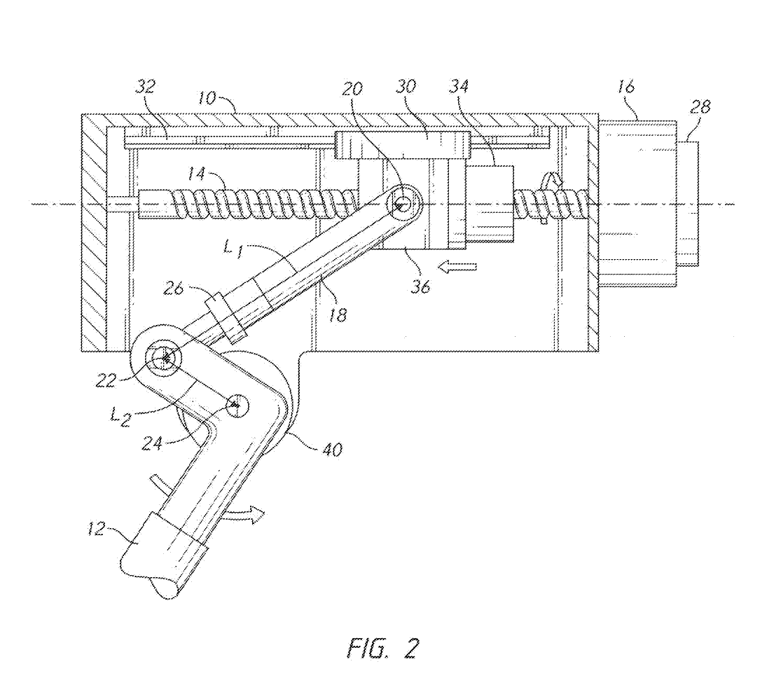

In studying FIG. 1, those skilled in the art will realize that actuating motor 16 causes screw 14 to turn. Carrier 36 will then be moved in a linear fashion. This motion will pivot both transfer link 18 and output link 12. FIG. 2 shows the relative position of these components after screw 14 has been driven through several revolutions. The motion of output link 12 is dependent upon the lengths L1 and L2.

Looking again at FIG. 1, the reader will note that controller 38 is provided to control the operation of the inventive actuator 2. It is generally desirable to control the angular position of output link 12 and the torque applied to output link 12. One can directly measure the angular position and torque. Alternatively, one can measure other values that may be used to determine the output link's angular position and the torque applied to it. In the example of FIG. 1, the angular position of motor 16 is fed to controller 38 by encoder 28. A mathematical function relates the angular position of the motor to the angular position of the output link, so the motor's position may be converted to the output link's position.

Similarly, load cell 26 is configured to measure the linear force applied by transfer link 18. A second mathematical function relates the linear force applied by transfer link 18 to the torque applied to output link 12, so the linear force may be converted to the output torque.

It is also possible to measure these values directly. In FIG. 2, encoder/torque sensor 40 has been installed proximate pivot pin 24. This component directly measures the angular position of the joint and the torque applied across the joint. In some applications it is advantageous to use a direct sensor since it can eliminate backlash and other sensing errors.

The inventive actuator provides the potential for a wide variety of non-linear motion transfers between the screw drive and the pivoting output link. For example, the actuator can provide an initial fast pivoting of the output link with relatively low available torque output followed by a slow pivoting final range of motion with a relatively high output torque.

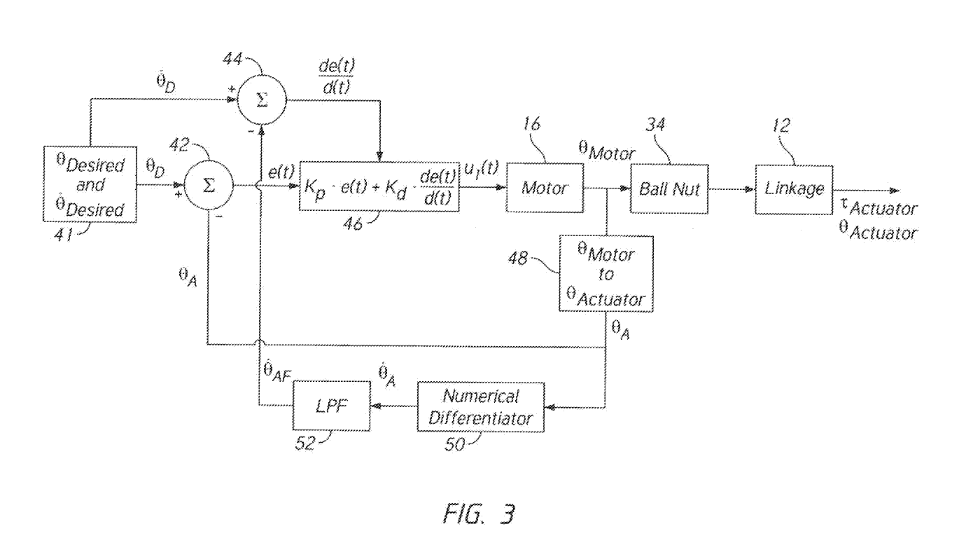

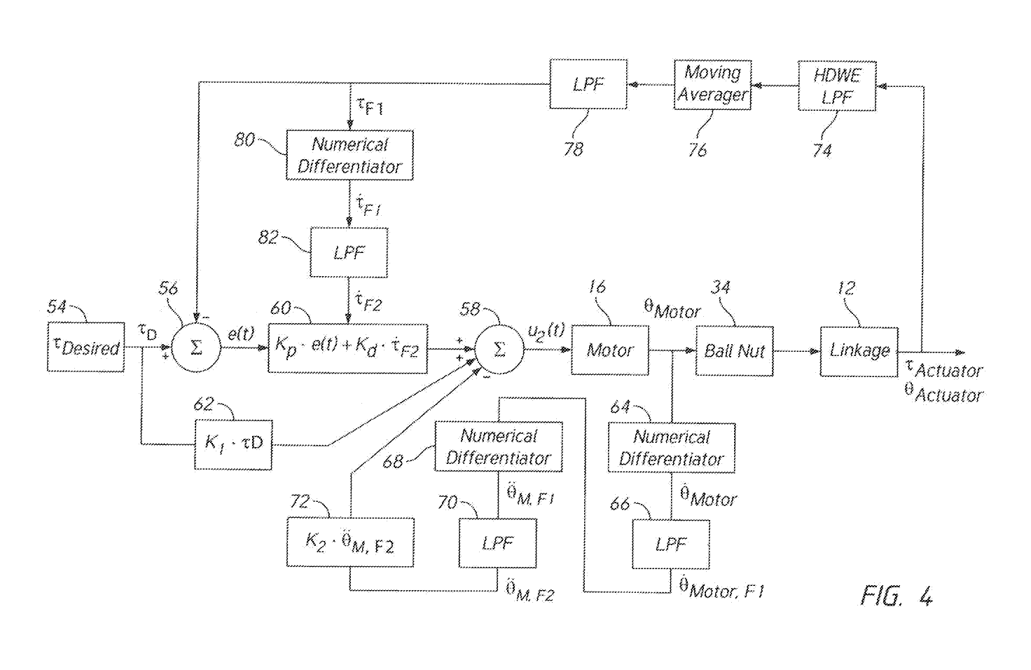

FIGS. 3 and 4 provide some information regarding exemplary control systems that could be used to control the motion of the inventive actuator. Many different approaches could be taken to controlling the device. In the exemplary approach of FIGS. 3 and 4, the goal is to control the angular position of output link 12 and the torque applied to output link 12. The only driving device is motor 16.

FIG. 3 shows a representative control system used to drive the angular position of the actuator output link. Function block 41 specifies the desired angular position of the output link (“theta”) and the desired angular velocity of the output link. The output of motor 16 is measured by encoder 28 (“theta motor”). Conversion function 48 is used to convert the motor's angular position to the angular position of the output link (“theta actuator”). As will be realized by those skilled in the art, it is straightforward to create a mathematical function relating the position of the output link to the angular position of the motor—since the motion of these two components is hard-linked together. “Theta actuator” is fed directly into summation block 42. In addition, another branch of the same signal is passed through numerical differentiator 50 to obtain the first derivative. This value is then passed through low pass filter 52 and into summation block 44.

A first error signal is produced by summation block 42 and a second error signal is produced by summation block 44. These two error signals are combined in control function block 46. The result is the control function (u1(t)) which is used to drive motor 16.

FIG. 4 shows an exemplary system used to control the torque applied to the output link. In this example, the angular position of the motor is used as one monitored value and the torque applied to the actuator is used as the other. One can directly measure the actuator torque (such as by using the torque sensor 40 in FIG. 2) or one can derive this value from load cell 26 or possible even from motor current.

In the example of FIG. 4, the desired output link torque is specified in input block 54. This value is fed into summation block 56. In addition, the same value is fed forward via control function 62. Control function 60 feeds into summation block 58. The output of summation block 58 is the control function (u2(t)) used to drive motor 16.

The resulting angular position of the motor is again used as a measured output. This value is fed into numerical differentiator 64. Then into low pass filter 66, then into numerical differentiator 68, then into low pass filter 70, then to control function 72, and finally to summation block 58.

The measured output torque for the actuator is fed to hardware-based low pass filter 74, then to moving average 76, then to low pass filter 78. From low pass filter 78 the signal is split. The first branch feeds into summation block 56. The second branch feeds into numerical differentiator 80, then to low pass filter 82, and then to control function 60.

Those skilled in the art will realize that many other variations are possible within the scope of the present invention. Thus, the scope should properly be fixed by the following claims rather than any particular example provided.

Having described my invention, I claim:

1. A linkage operating mechanism, comprising:
a. a frame;
b. a screw, rotatable mounted to said frame;
c. a motor fixedly mounted to said frame, said motor driving said screw;
d. a ball nut mounted on said screw;
e. a carrier attached to said ball nut;
f. an output link, pivotally connected to said frame at a first pivot joint;
g. a transfer link having a first end and a second end;
h. said first end of said transfer link being pivotally connected to said carrier at a second pivot joint; and
i. said second end of said transfer link being pivotally connected to said output link at a third pivot joint.

2. The linkage operating mechanism as recited in claim 1, further comprising a linear bearing mounted to said frame, with said carrier riding along said linear bearing.

3. The linkage operating mechanism as recited in claim 1, wherein said second pivot joint include a first trunnion on a first side of said carrier and a second trunnion on a second side of said carrier.

4. The linkage operating mechanism as recited in claim 1, further comprising an encoder for monitoring an angular position of said motor.

5. The linkage operating mechanism as recited in claim 4, further comprising a controller using data from said encoder to drive a desired position of said output link.

6. The linkage operating mechanism as recited in claim 4, further comprising a load cell for measuring a force applied to said transfer link.

7. The linkage operating mechanism as recited in claim 6, further comprising a controller using data from said encoder and said load cell to drive a desired position of said output link and a desired torque applied to said output link.

8. The linkage operating mechanism as recited in claim 1, further comprising a rotary encoder placed on said first pivot joint to measure an angular position of said output link.

9. The linkage operating mechanism as recited in claim 8, further comprising a controller using data from said rotary encoder placed on said first pivot joint to drive a desired angular position for said output link.

10. The linkage operating mechanism as recited in claim 9, further comprising a torque sensor configured to sense torque across said first pivot joint.

11. A linkage operating mechanism, comprising:
a. a frame;
b. a screw, rotatable mounted to said frame;
c. a motor fixedly mounted to said frame, said motor driving said screw;
d. a rotation-limited nut mounted on said screw, said rotation-limited nut configured to convert rotary motion of said screw into linear motion of said nut;
e. an output link, pivotally connected to said frame at a first pivot joint;
f. a transfer link having a first end and a second end;
g. said first end of said transfer link being pivotally connected to said nut at a second pivot joint; and
h. said second end of said transfer link being pivotally connected to said output link at a third pivot joint.

12. The linkage operating mechanism as recited in claim 11, further comprising:
a. a carrier attached to said nut; and
b. a linear bearing mounted to said frame, with said carrier riding along said linear bearing.

13. The linkage operating mechanism as recited in claim 12, wherein said second pivot joint include a first trunnion on a first side of said carrier and a second trunnion on a second side of said carrier.

14. The linkage operating mechanism as recited in claim 11, further comprising an encoder for monitoring an angular position of said motor.

15. The linkage operating mechanism as recited in claim 14, further comprising a controller using data from said encoder to drive a desired position of said output link.

16. The linkage operating mechanism as recited in claim 14, further comprising a load cell for measuring a force applied to said transfer link.

17. The linkage operating mechanism as recited in claim 16, further comprising a controller using data from said encoder and said load cell to drive a desired position of said output link and a desired torque applied to said output link.

18. The linkage operating mechanism as recited in claim 11, further comprising a rotary encoder placed on said first pivot joint to measure an angular position of said output link.

19. The linkage operating mechanism as recited in claim 18, further comprising a controller using data from said rotary encoder placed on said first pivot joint to drive a desired angular position for said output link.

20. The linkage operating mechanism as recited in claim 19, further comprising a torque sensor configured to sense torque across said first pivot joint.
